(19) United States
(12) Patent Application Publication
(10) Pub. No.: US 2015/0249903 A1
(43) Pub. Date: Sep. 3, 2015

(54) ELECTRONIC DEVICE AND TRANSFER CONTROL METHOD

(71) Applicant: KYOCERA Corporation, Kyoto-shi, Kyoto (JP)

(72) Inventors: Hiroyuki Bamba, Sagamihara-shi (JP); Nayu Nomachi, Minoh-shi (JP); Tomohiro Sudou, Yokohama-shi (JP)

(21) Appl. No.: 14/431,162

(22) PCT Filed: Sep. 26, 2013
(86) PCT No.: PCT/JP2013/076047

§ 371 Date: Mar. 25, 2015

(30) Foreign Application Priority Data
Sep. 28, 2012 (JP) 2012-218169

(51) Int. Cl. H04W 4/00; H04M 1/725

(52) U.S. Cl. CPC H04W 4/008; H04M 1/7253

(57) ABSTRACT

According to one of aspects, an electronic device includes: a first communication unit configured to perform communication with a first electronic device using a first communication scheme; a second communication unit configured to perform communicate with the first electronic device using a second communication scheme; and a control unit. In a state in which the first communication unit cannot be used for informing the first electronic device of an incoming call from a second electronic device, the control unit informs the first electronic device of the incoming call using the second communication unit.

### CROSS-REFERENCE TO RELATED APPLICATION

This application is a National Stage of PCT international application Ser. No. PCT/JP2013/076047 filed on Sep. 26, 2013 which designates the United States, incorporated herein by reference, and which is based upon and claims the benefit of priority from Japanese Patent Application No. 2012-218169 filed on Sep. 28, 2012, the entire contents of which are incorporated herein by reference.

### FIELD

The present application relates to an electronic device and a transfer control method.

### BACKGROUND

Techniques are known in which, when an incoming call is received by a mobile phone, communication related to the incoming call is performed using another electronic device. For example, a separated mobile phone of wireless headset type, which includes a short-range wireless communication module employing the Bluetooth (registered trademark) standard, has been developed. This technique allows a user to make or receive a phone call with a headset attached to his or her ear and a mobile phone placed inside a bag.

### SUMMARY

According to one of aspects, an electronic device includes: a first communication unit configured to perform communication with a first electronic device using a first communication scheme; a second communication unit configured to perform communicate with the first electronic device using a second communication scheme; and a control unit. In a state in which the first communication unit cannot be used for informing the first electronic device of an incoming call from a second electronic device, the control unit informs the first electronic device of the incoming call using the second communication unit.

According to one of aspects, a transfer control method is performed by an electronic device including a first communication unit and a second communication unit. The transfer control method includes: detecting an incoming call from a second electronic device; informing a first electronic device of the incoming call using the first communication unit; and when the first communication unit cannot be used for informing the first electronic device of the incoming call, informing the first electronic device of the incoming call using the second communication unit.

### BRIEF DESCRIPTION OF DRAWINGS

FIG. 1 is a diagram illustrating one of examples of transfer of an incoming call.

FIG. 2 is a diagram illustrating one of examples of informing performed when short-range communication is unavailable.

FIG. 3 is a block diagram illustrating a mobile phone that transfers an incoming call.

FIG. 4 is a diagram illustrating one of examples of incoming call history data.

FIG. 5 is a block diagram illustrating a mobile phone to which an incoming call is transferred.

FIG. 6 is a flowchart illustrating an incoming call control process.

FIG. 7 is a flowchart illustrating an incoming call history transmission process.

FIG. 8 is a flowchart illustrating an incoming call-related notification process.

### DESCRIPTION OF EMBODIMENT

Embodiments for carrying out the present disclosure will be described in detail with reference to the accompanying drawings. When the electronic device such as the headset becomes unable to perform the short-range wireless communication with the mobile phone for some reason, the headset is not informed by the mobile phone of an incoming call received by the mobile phone. Thus, the user may not be able to notice the incoming call, if he or she is attentive only to the electronic device such as the headset. For the foregoing reasons, there is a need for an electronic device and a transfer control method that can increase the likelihood that the user will notice the incoming call.

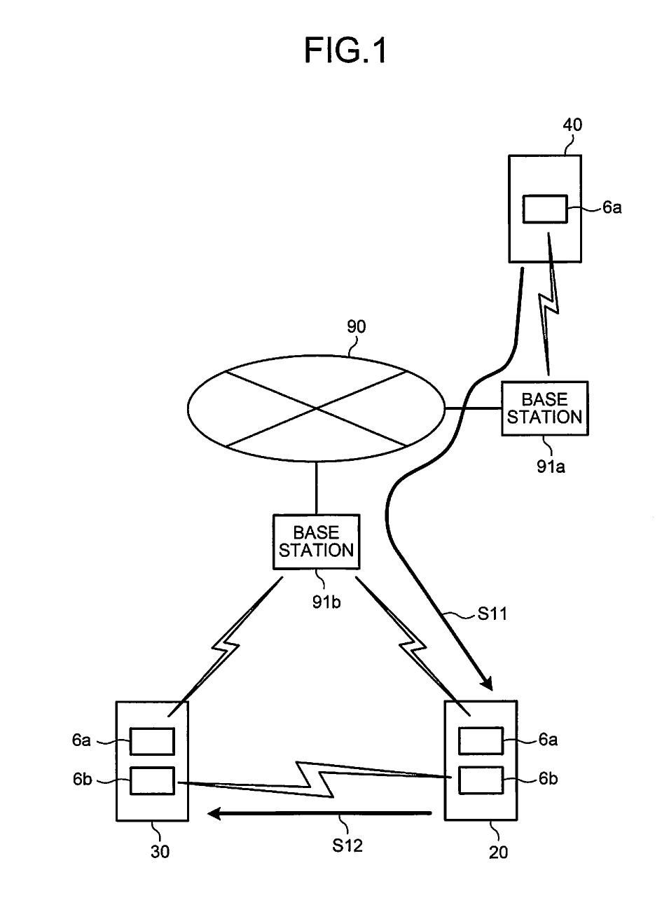

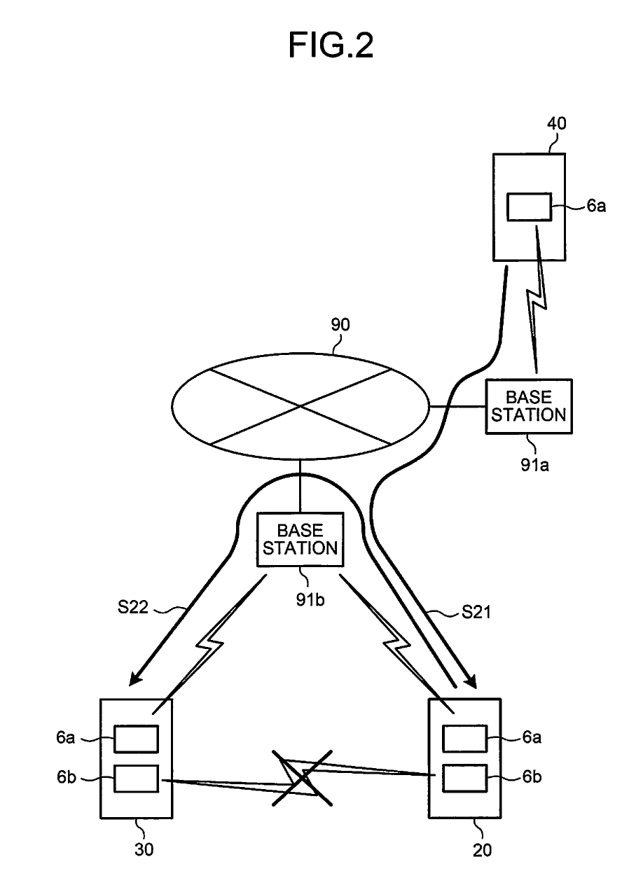

The following describes a transfer control method according to one of embodiments with reference to FIGS. 1 and 2. FIG. 1 is a diagram illustrating one of examples of transfer of an incoming call. Mobile phones 20, 30, and 40 illustrated in FIG. 1 each include a communication unit 6a. The mobile phones 20 and 30 each further include a communication unit 6b.

The communication unit 6a is configured to be capable of performing a telephone conversation through a public line network 90. In a scene illustrated in FIG. 1, the communication unit 6a of each of the mobile phones 20 and 30 is connected to the public line (carrier line) network 90 via wireless communication with a base station 91b. In the scene illustrated in FIG. 1, the communication unit 6a of the mobile phone 40 is connected to the public line (carrier line) network 90 via wireless communication with a base station 91a.

The communication unit 6b is configured to be capable of performing a telephone conversation through short-range wireless communication, such as the Bluetooth (registered trademark). In the scene illustrated in FIG. 1, the communication units 6b of the mobile phones 20 and 30 are capable of communicating with each other.

The mobile phones 20 and 30 are owned by the same user. The mobile phone 20 is set such that, when an incoming call is received, the mobile phone 20 transfers the incoming call to the mobile phone 30 through the short-range wireless communication by the communication unit 6b. Assume, for example, that the mobile phone 40 performs an outgoing call to the mobile phone 20 at Step S11. This outgoing call reaches the mobile phone 20 via the base station 91a, the public line network 90, and the base station 91b.

Upon detecting the incoming call, the mobile phone 20 transfers the incoming call to the mobile phone 30 via the short-range wireless communication by the communication unit 6b (communication using a first communication scheme) at Step S12. Upon detecting the incoming call, the mobile phone 30 notifies the user of the incoming call using a ring tone, vibration, a blinking lamp, or the like. Noticing the notification, the user performs a predetermined off-hook operation. This operation starts a telephone conversation between the mobile phone 30 and the mobile phone 40. The off-hook operation is an operation to start the telephone conversation in response to the incoming call. During the telephone conversation, the mobile phone 20 relays an exchange of voice data between the mobile phone 30 and the mobile phone 40. When one of them disconnects the call, the mobile phone 20 disconnects the connection of the telephone conversation with the other.

The mobile phone 30 also notifies the user of the incoming call using a ring tone, vibration, a blinking lamp, or the like when detecting an incoming call made to a telephone number assigned to itself. The predetermined off-hook operation by the user who has noticed the notification starts a telephone conversation between the mobile phone 30 and the mobile phone that has originated the call. In this case, the mobile phone 20 does not relay voice data.

As described above, the incoming call made to the mobile phone 20 is transferred to the mobile phone 30 through the short-range wireless communication. This allows the user to answer an incoming call made to any mobile phone owned by the user with a single mobile phone. In addition, the transfer through the short-range wireless communication eliminates a communication charge that would otherwise be incurred when the incoming call is transferred through the public line network 90.

FIG. 2 is a diagram illustrating one of examples of informing performed when the short-range wireless communication is unavailable. The configurations of devices included in the example illustrated in FIG. 2 are the same as those illustrated in FIG. 1. In a scene illustrated in FIG. 2, however, the short-range wireless communication between the mobile phone 20 and the mobile phone 30 is unavailable for some reason. In this case, when the mobile phone 40 originates a call to the mobile phone 20 at Step S21, the call reaches the mobile phone 20 via the base station 91a, the public line network 90, and the base station 91b.

The mobile phone 20, which is set to transfer an incoming call to the mobile phone 30 through the short-range wireless communication by the communication unit 6b (communication using the first communication scheme), is unable to perform the short-range wireless communication and is thus unable to perform the transfer through the short-range wireless communication. When the communication by the communication unit 6b is unavailable as described above, the mobile phone 20 informs the mobile phone 30 of the incoming call via communication by the communication unit 6a (communication using a second communication scheme) at Step S22. Informing an incoming call (information of an incoming call) includes transmitting information relating to the incoming call and transferring the incoming call.

The mobile phone 30, having received the information of the incoming call via the communication by the communication unit 6a, notifies the information of the incoming call to the user using a ring tone, vibration, a blinking lamp, or the like. By notifying the user of the reception of the information of the incoming call through the communication by the communication unit 6a as described above, the mobile phone 30 can inform the user of the incoming call to the mobile phone 20 even when the communication by the communication unit 6b is unavailable. In addition, when the mobile phone 20 transfers the incoming call to the mobile phone 30 via the communication by the communication unit 6a, the mobile phone 30 enables the user to perform a telephone conversation using the mobile phone 30 in response to the incoming call to the mobile phone 20 even when the communication by the communication unit 6b is unavailable.

The mobile phone 30 may vary a mode of the notification between when the information of the incoming call is received via the communication by the communication unit 6a, and when the incoming call is detected via the communication unit 6b. By varying the mode of the notification, the mobile phone 30 can inform the user of a status of communication by the communication unit 6b, in addition to the incoming call to the mobile phone 20.

In the above description, the case has been described in which the mobile phone 20 informs the mobile phone 30 of an incoming call via the communication by the communication unit 6a when the communication by the communication unit 6b is unavailable. However, the case in which the mobile phone 20 informs the mobile phone 30 of an incoming call via the communication by the communication unit 6a is not limited thereto. For example, the mobile phone 20 informs the mobile phone 30 of an incoming call via the communication by the communication unit 6a also when the communication by the communication unit 6b is unstable. Examples of cases of the unstable communication include, but are not limited to, a case in which exchanged signals contain much noise and are inferior in quality, a case in which received signals are of a weak electric field, a case in which a reception error is greater than a threshold, and a case in which a frequency at which connection and disconnection occur is greater than a threshold. The use of the communication by the communication unit 6a when the communication by the communication unit 6b is unstable allows the user to be informed of an incoming call to the mobile phone 20 and reduces the likelihood that voice will be hardly heard or the call will be interrupted during a telephone conversation.

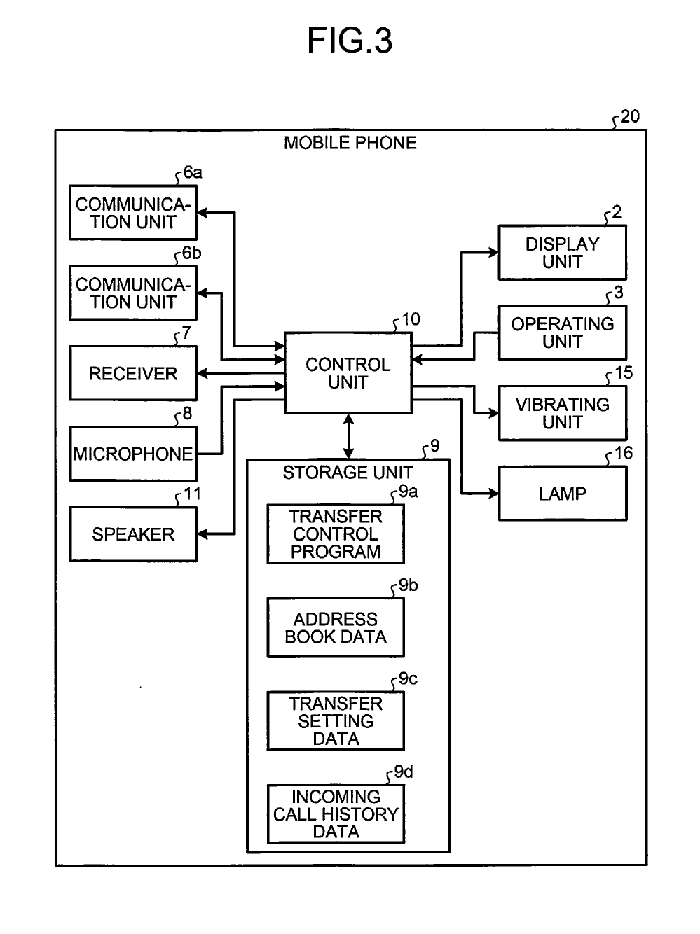

The following describes, with reference to FIGS. 3 to 5, configurations of the mobile phone 20 and the mobile phone 30 illustrated in FIGS. 1 and 2. In the following description, like parts may be identified by the same reference numerals and any redundant description may be omitted.

FIG. 3 is a block diagram illustrating the mobile phone 20, that is, the mobile phone that transfers incoming calls. As illustrated in FIG. 3, the mobile phone 20 includes a display unit 2, an operating unit 3, communication units 6a and 6b, a receiver 7, a microphone 8, a storage unit 9, a control unit 10, a speaker 11, a vibrating unit 15, and a lamp 16.

The display unit 2 includes a display panel such as a liquid crystal display or an organic electro-luminescence display. The display unit 2 displays information such as characters, graphics, and images in accordance with a signal input from the control unit 10. The information displayed on the display unit 2 includes a screen for notification, an icon, etc.

The operating unit 3 includes one or a plurality of devices for receiving operations performed by the user. Examples of the devices for receiving the operations performed by the user include, but are not limited to, a key, a button, a touch screen, etc. The operating unit 3 inputs a signal corresponding to the received operation to the control unit 10.

The communication unit 6a performs communication using the second communication scheme. In the embodiment, the second communication scheme is a communication scheme for performing communication via the public line network 90, such as 2G, 3G, and 4G. Examples of communication standards for performing communication via the public line network 90 include, but are not limited to, Long Term Evolution (LTE), Wideband Code Division Multiple Access (W-CDMA), CDMA2000, Personal Digital Cellular (PDC), Global System for Mobile Communications (GSM (registered trademark)), Personal Handy-phone System (PHS), etc. The second communication scheme may be a communication scheme for performing data communication over the public line network 90, such as Worldwide Interoperability for Microwave Access (WiMAX). When the second communication scheme is a communication scheme for performing data communication, a telephone conversation is achieved by combining a data transmission technique with a technique for transmitting voice as data, such as Voice over Internet Protocol (VoIP). The communication unit 6a may support a plurality of communication schemes for performing communication via the public line network 90.

The communication unit 6b performs communication using the first communication scheme. In the embodiment, the first communication scheme is a short-range wireless communication scheme. Examples of the short-range wireless communication scheme include, but are not limited to, Bluetooth (registered trademark), wireless LAN (IEEE802.11), ZigBee, infrared communication, visible light communication, near field communication (NFC), etc. The communication unit 6b may support a plurality of short-range wireless communication schemes.

The receiver 7 and the speaker 11 are sound output units. The receiver 7 and the speaker 11 each output a sound signal input from the control unit 10 as sound. The receiver 7 is used for outputting, for example, the voice of a remote party during a telephone conversation. The speaker 11 is used for outputting, for example, a ring tone and music. Either the receiver 7 or the speaker 11 may additionally have a function of the other. The microphone 8 is a sound input unit. The microphone 8 converts the voice of the user or the like to a sound signal and inputs the resultant sound signal to the control unit 10.

The storage unit 9 stores therein computer programs and data. The storage unit 9 is used also as a work space that temporarily stores therein results of processing performed by the control unit 10. The storage unit 9 may include any non-transitory storage medium such as a semiconductor storage medium, a magnetic storage medium, etc. The storage unit 9 may include a plurality of types of storage media. The storage unit 9 may include a combination of a portable storage medium, such as a memory card, an optical disc, or a magneto-optical disc, and a storage medium reading device. The storage unit 9 may include a storage device used as a temporary storage space such as a random access memory (RAM).

The storage unit 9 stores therein, for example, a transfer control program 9a, address book data 9b, transfer setting data 9c, and incoming call history data 9d. The transfer control program 9a provides an electronic device that transfers incoming calls with an incoming call transfer function for controlling transfer of the incoming calls. The address book data 9b includes various types of information on the remote party of a telephone conversation. The transfer setting data 9c includes information on various types of settings relating to the transfer of the incoming calls. The incoming call history data 9d records information on the incoming calls.

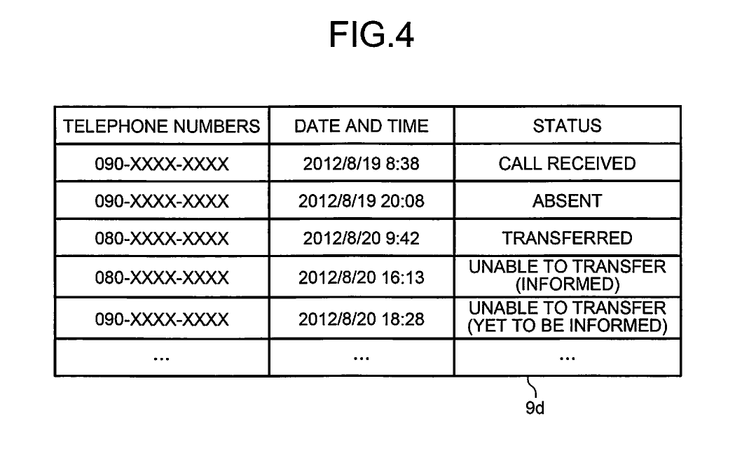

FIG. 4 illustrates one of examples of the incoming call history data 9d. As illustrated in FIG. 4, the incoming call history data 9d records, for example, a telephone number, a date and time, and a status for each incoming call. The telephone number is a telephone number of a telephone set that originates the call to the mobile phone 20. The date and time is a specific date and time at which the incoming call is detected. The status is a value that indicates a result of the incoming call. The status takes any of the following values: “call received”, “absent”, “transferred”, “unable to transfer (informed)”, and “unable to transfer (yet to be informed)”.

“Call received” indicates that a setting to transfer the incoming call to the mobile phone 30 was not made and the mobile phone 20 received the incoming call. The reception of the incoming call by the mobile phone 20 signifies that a status for allowing a telephone conversation was established through, for example, an off-hook operation performed by the user. “Absent” indicates that a setting to transfer the incoming call to the mobile phone 30 was not made and the call was disconnected before the mobile phone 20 receives the incoming call.

“Transferred” indicates that a setting to transfer the incoming call to the mobile phone 30 was made and the incoming call was transferred to the mobile phone 30 through the communication by the communication unit 6b. “Unable to transfer (informed)” indicates that a setting to transfer the incoming call to the mobile phone 30 was made, but the incoming call was informed to the mobile phone 30 through the communication by the communication unit 6a because the communication by the communication unit 6b was unavailable. “Unable to transfer (yet to be informed)” indicates that, in a scene similar to that in “unable to transfer (informed)”, informing failed because the communication by the communication unit 6a was unavailable despite an attempt to inform the mobile phone 30 of the incoming call through the communication by the communication unit 6a.

The control unit 10 is a processing unit. Examples of the processing unit include, but are not limited to, a central processing unit (CPU), a system-on-a-chip (SoC), a micro control unit (MCU), and a field-programmable gate array (FPGA). The control unit 10 integrally controls operations of the mobile phone 20 to thereby achieve various types of functions.

Specifically, the control unit 10 executes instructions included in the programs stored in the storage unit 9, while referring to data stored in the storage unit 9 as necessary. The control unit 10 controls a functional unit according to the data and the instructions and thereby achieves various types of functions. Examples of the functional unit include, but are not limited to, the display unit 2, the communication units 6a and 6b, the receiver 7, the speaker 11, the vibrating unit 15, and the lamp 16. The control unit 10 may change its control depending on a result of detection made by a detecting unit. Examples of the detecting unit include, but are not limited to, the operating unit 3, the communication units 6a and 6b, and the microphone 8.

The control unit 10 executes the transfer control program 9a to thereby achieve operations of the mobile phone 20 in the transfer control method illustrated in FIGS. 1 and 2. In addition, the control unit 10 executes the transfer control program 9a to thereby transmit information relating to an incoming call, which could not be transferred to the mobile phone 30, to the mobile phone 30 when communication with the mobile phone 30 is later available. As described above, the information relating to the incoming call that could not be transferred is transferred after communication is recovered. This allows the user to be informed of the incoming call that could not be transferred. Processing steps performed by the control unit 10 on the basis of the transfer control program 9a will be described in detail later.

The vibrating unit 15 vibrates the mobile phone 20. To vibrate the mobile phone 20, the vibrating unit 15 uses, for example, a piezoelectric element or an eccentric motor. The lamp 16 emits light in set color and pattern. The lamp 16 includes a light source such as a light emitting diode (LED) and is mounted on the mobile phone 20 in such a manner that the light emitted by the light source is visually recognizable from the outside. The display unit 2, the speaker 11, the vibrating unit 15, and the lamp 16 are used for notifying an incoming call, reception of an e-mail, arrival of previously scheduled time, and the like to the user.

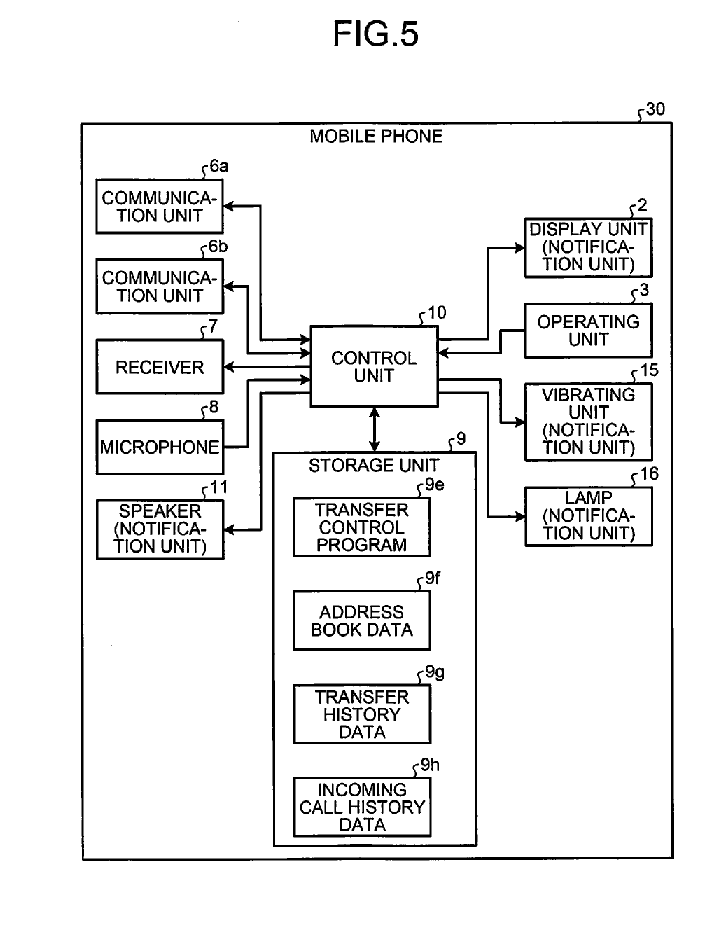

FIG. 5 is a block diagram illustrating the mobile phone 30, that is, the mobile phone to which incoming calls are transferred. As illustrated in FIG. 5, the mobile phone 30 includes a display unit 2, an operating unit 3, communication units 6a and 6b, a receiver 7, a microphone 8, a storage unit 9, a control unit 10, a speaker 11, a vibrating unit 15, and a lamp 16.

The storage unit 9 stores therein, for example, a transfer control program 9e, address book data 9f, transfer history data 9g, and incoming call history data 9h. The transfer control program 9e provides an electronic device to which incoming calls are transferred with an incoming call transfer function for controlling transfer of incoming calls. As with the address book data 9b, the address book data 9f includes various types of information on the remote party of a telephone conversation. The transfer history data 9g records information on transferred incoming calls. The information on the transferred incoming calls include, for example, the telephone number of a telephone set that originates a call to a transfer source telephone set (the mobile phone 20 in this example), a time at which the transfer of an incoming call or informing of the incoming call is detected, and a value that indicates a result of the transfer of the incoming call or informing of the incoming call. The data recorded in the transfer history data 9g is displayed on the display unit 2 as invoked by, for example, an operation performed by the user. As with the incoming call history data 9d, the incoming call history data 9h records information on incoming calls made to the mobile phone 30.

The control unit 10 executes the transfer control program 9e to thereby achieve operations of the mobile phone 30 in the transfer control method illustrated in FIGS. 1 and 2. Processing steps performed by the control unit 10 on the basis of the transfer control program 9e will be described in detail later.

The display unit 2, the speaker 11, the vibrating unit 15, and the lamp 16 function as notification units for notifying an incoming call, reception of an e-mail, arrival of previously scheduled time, and the like to the user.

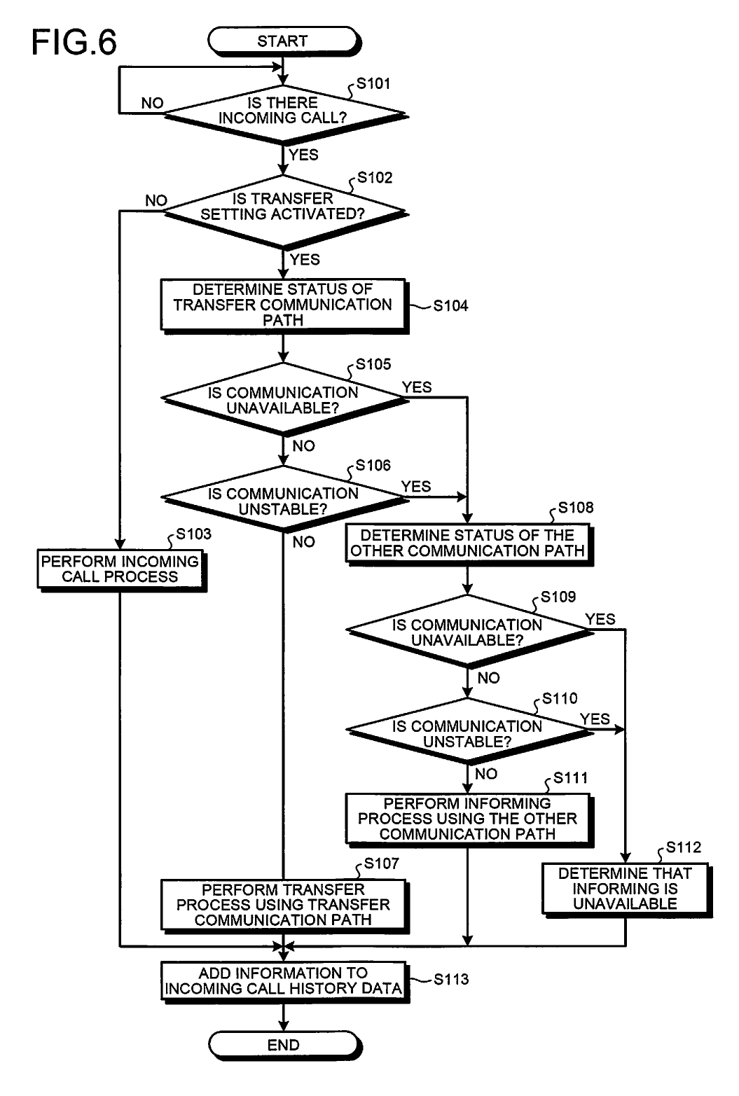

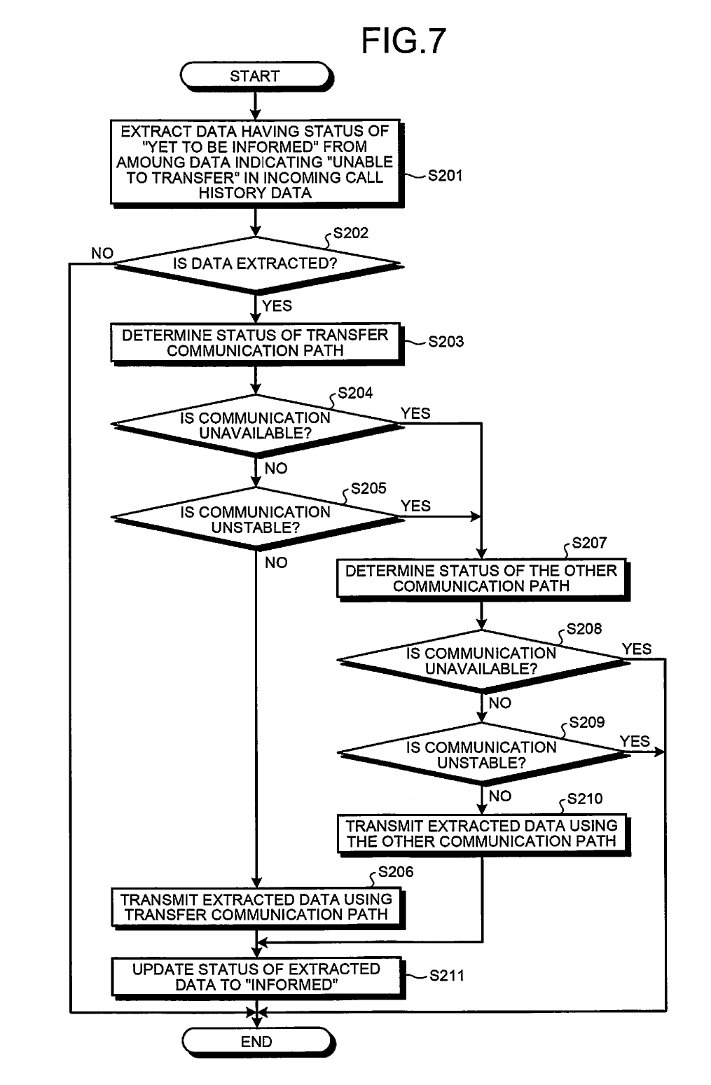

The following describes, with reference to FIGS. 6 and 7, the processing steps performed by the control unit 10 of the mobile phone 20 on the basis of the transfer control program 9a. FIG. 6 is a flowchart illustrating processing steps performed in an incoming call control process. The processing steps illustrated in FIG. 6 are repeatedly performed.

The control unit 10 of the mobile phone 20 determines at Step S101 whether there is an incoming call. When it is determined that there is no incoming call (No at Step S101), the control unit 10 performs Step S101 again. When it is determined that there is an incoming call (Yes at Step S101), the control unit 10 proceeds to Step S102.

At Step S102, the control unit 10 determines whether the setting for transferring the incoming call is activated. Whether the setting for transferring the incoming call is activated is determined by, for example, referring to the transfer setting data 9c. When it is determined that the setting for transferring the incoming call is not activated (No at Step S102), the control unit 10 performs, at Step S103, an incoming call process for receiving the incoming call with the mobile phone 20.

In the incoming call process, the control unit 10 notifies the user of the incoming call by, for example, displaying an incoming call screen on the display unit 2, outputting a ring tone from the speaker 11, vibrating the vibrating unit 15, and flashing the lamp 16 off and on. The control unit 10, when having detected an off-hook operation by the user, terminates the notification and starts a telephone conversation with an originating end. The off-hook operation may be any operation, such as pressing an off-hook button or a gesture performed over a touch screen. When the call is disconnected before the detection of the off-hook operation, the control unit 10 terminates the notification without starting the telephone conversation.

After performing the incoming call process, the control unit 10 adds information on a result of the incoming call to the incoming call history data 9d at Step S113. In this case, “call received” or “absent” is set for the status of the information added in the incoming call history data 9d. The control unit 10 then terminates the incoming call control process.

When it is determined that the setting for transferring the incoming call is activated (Yes at Step S102), the control unit 10 determines the status of a transfer communication path at Step S104. The transfer communication path is a communication path established using the first communication scheme via the communication unit 6b. On the basis of a result of the determination made at Step S104, the control unit 10 determines at Step S105 whether the communication through the transfer communication path is unavailable. When it is determined that the communication through the transfer communication path is not unavailable (No at Step S105), the control unit 10 proceeds to Step S106.

At Step S106, the control unit 10 determines whether the communication through the transfer communication path is unstable on the basis of the result of the determination made at Step S104. When it is determined that the communication through the transfer communication path is not unstable (No at Step S106), the control unit 10 proceeds to Step S107. At Step S107, the control unit 10 performs a transfer process through the transfer communication path. The transfer process is a process for enabling a telephone conversation between an originating end electronic device and a transfer destination electronic device. In the transfer process, the control unit 10 acquires information required for the transfer process, such as transfer destination identification information, from the transfer setting data 9c.

After performing the transfer process, the control unit 10 adds information on a result of the incoming call to the incoming call history data 9d at Step S113. In this case, “transferred” is set for the status of the information added in the incoming call history data 9d.

When it is determined that the communication through the transfer communication path is unavailable or unstable (Yes at Step S105 or Yes at Step S106), the control unit 10 proceeds to Step S108. At Step S108, the control unit 10 determines the status of the other communication path. The other communication path is a communication path established using the second communication scheme via the communication unit 6a. On the basis of the result of the determination made at Step S108, the control unit 10 determines whether the communication through the other communication path is unavailable at Step S109. When it is determined that the communication through the other communication path is not unavailable (No at Step S109), the control unit 10 proceeds to Step S110.

At Step S110, the control unit 10 determines whether the communication through the other communication path is unstable on the basis of the result of the determination made at Step S108. When it is determined that the communication through the other communication path is not unstable (No at Step S110), the control unit 10 proceeds to Step S111. At Step S111, the control unit 10 performs an informing process using the other communication path. The informing process is a process for informing the transfer destination electronic device of the incoming call. In the informing process, the control unit 10 acquires information required for the informing process, such as transfer destination identification information, from the transfer setting data 9c.

After performing the informing process, the control unit 10 adds information on a result of the incoming call to the incoming call history data 9d at Step S113. In this case, “unable to transfer (informed)” is set for the status of the information added in the incoming call history data 9d.

When it is determined that the communication through the other communication path is unavailable or unstable (Yes at Step S109 or Yes at Step S110), the control unit 10 proceeds to Step S112. At Step S112, the control unit 10 determines that informing of the incoming call is unavailable. The control unit 10 then ads information on the result of the incoming call in the incoming call history data 9d at Step S113. In this case, “unable to transfer (yet to be informed)” is set for the status of the information added in the incoming call history data 9d.

FIG. 7 is a flowchart illustrating processing steps performed in an incoming call history transmission process. The processing steps illustrated in FIG. 7 are performed at regular intervals to transmit the information relating to the incoming call that could not be transferred, to the transfer destination.

The control unit 10 of the mobile phone 20 extracts, at Step S201, data relating to an incoming call of which transfer fails and of which informing to the transfer destination is yet to be completed from the incoming call history data 9d. Specifically, the control unit 10 extracts data having “unable to transfer (yet to be informed)” set for the status. When the data is not extracted, in other words, when there is no data to be transmitted (No at Step S202), the control unit 10 terminates the incoming call history transmission process.

When the data is extracted (Yes at Step S202), the control unit 10 proceeds to Step S203. The control unit 10 determines the status of the transfer communication path at Step S203. The transfer communication path is a communication path established using the first communication scheme via the communication unit 6b. On the basis of a result of the determination made at Step S203, the control unit 10 determines at Step S204 whether the communication through the transfer communication path is unavailable. When it is determined that the communication through the transfer communication path is not unavailable (No at Step S204), the control unit 10 proceeds to Step S205.

At Step S205, the control unit 10 determines whether the communication through the transfer communication path is unstable on the basis of the result of the determination made at Step S203. When it is determined that the communication through the transfer communication path is not unstable (No at Step S205), the control unit 10 proceeds to Step S206. At Step S206, the control unit 10 transmits, through the transfer communication path, the data extracted at Step S201 to the electronic device set as the transfer destination of the incoming call. The control unit 10 acquires information required for the transmission of the data, such as transfer destination identification information, from the transfer setting data 9c.

After the transmission of the data, the control unit 10 changes, at Step S211, the status of the data extracted at Step S201 to a value indicating that the data has been informed. Specifically, the control unit 10 changes the status of the data to “unable to transfer (informed)”. The control unit 10 then terminates the incoming call history transmission process.

When it is determined that the communication through the transfer communication path is unavailable or unstable (Yes at Step S204 or Yes at Step S205), the control unit 10 proceeds to Step S207. At Step S207, the control unit 10 determines the status of the other communication path. The other communication path is a communication path established using the second communication scheme via the communication unit 6a. On the basis of the result of the determination made at Step S207, the control unit 10 determines whether the communication through the other communication path is unavailable at Step S208. When it is determined that the communication through the other communication path is not unavailable (No at Step S208), the control unit 10 proceeds to Step S209.

At Step S209, the control unit 10 determines whether the communication through the other communication path is unstable on the basis of the result of the determination made at Step S207. When it is determined that the communication through the other communication path is not unstable (No at Step S209), the control unit 10 proceeds to Step S210. At Step S210, the control unit 10 transmits, through the other communication path, the data extracted at Step S201 to the electronic device set as the transfer destination of the incoming call. The control unit 10 acquires information required for the transmission of the data, such as transfer destination identification information, from the transfer setting data 9c.

After the transmission of the data, the control unit 10 changes, at Step S211, the status of the data extracted at Step S201 to a value indicating that the data has been informed. Specifically, the control unit 10 changes the status of the data to “unable to transfer (informed)”. The control unit 10 then terminates the incoming call history transmission process.

When it is determined that the communication through the other communication path is unavailable or unstable (Yes at Step S208 or Yes at Step S209), the control unit 10 terminates the incoming call history transmission process without transmitting the data extracted at Step S201.

While FIG. 7 illustrates one of examples of the case in which, in the incoming call history transmission process, the data extracted at Step S201 is transmitted preferentially through the transfer communication path, the other communication path may preferentially be used. In that case, Steps S207 to S210 are performed in advance of Step S203.

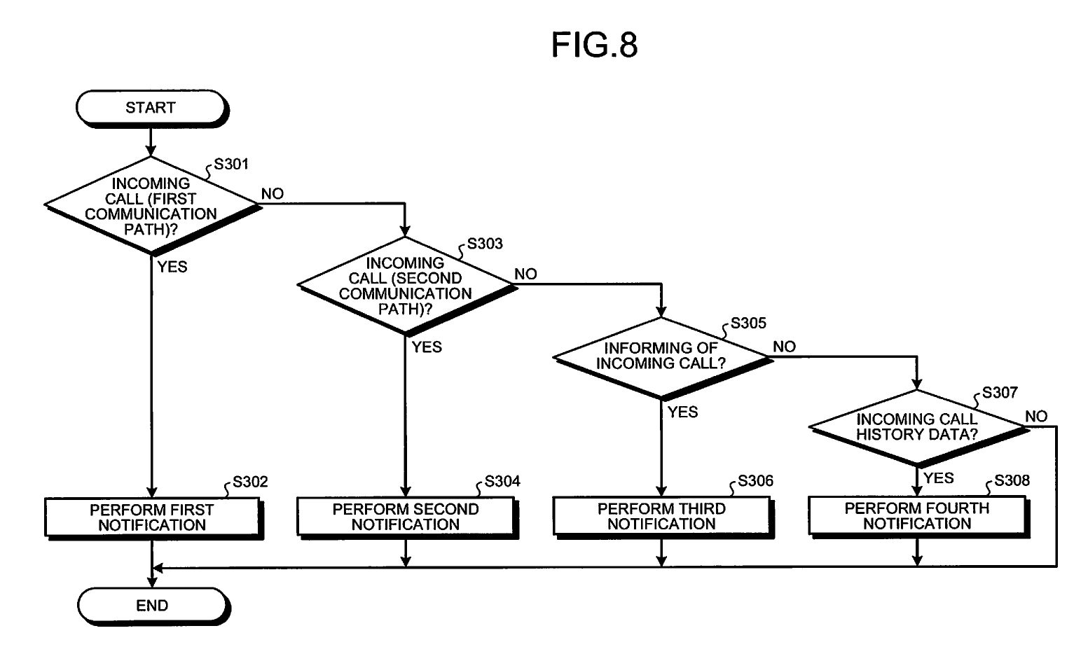

The following describes, with reference to FIG. 8, the processing steps performed by the control unit 10 of the mobile phone 30 on the basis of the transfer control program 9e. FIG. 8 is a flowchart illustrating processing steps for an incoming call-related notification process. The processing steps illustrated in FIG. 8 are performed when information relating to an incoming call is received.

The control unit 10 of the mobile phone 30 determines, at Step S301, whether an incoming call via a first communication path is detected, that is, whether the incoming call is detected by a first communication unit. The incoming call via the first communication path is a transferred incoming call. When it is determined that the incoming call via the first communication path is detected (Yes at Step S301), the control unit 10 proceeds to Step S302. At Step S302, the control unit 10 performs a first notification using a notification unit, and then terminates the notification process. When it is determined that no incoming call via the first communication path is detected (No at Step S301), the control unit 10 proceeds to Step S303.

At Step S303, the control unit 10 determines whether an incoming call via a second communication path is detected, that is, whether the incoming call is detected by a second communication unit. The incoming call via the second communication path is an incoming call to the telephone number of the mobile phone 30. When it is determined that the incoming call via the second communication path is detected (Yes at Step S303), the control unit 10 proceeds to Step S304. At Step S304, the control unit 10 performs a second notification using a notification unit, and then terminates the notification process. When it is determined that no incoming call via the second communication path is detected (No at Step S303), the control unit 10 proceeds to Step S305.

At Step S305, the control unit 10 determines whether informing of the incoming call via the second communication unit is detected, that is, whether informing of the incoming call is detected by the second communication unit. Informing of the incoming call via the second communication path is performed when the incoming call cannot be transferred via the first communication path. When it is determined that informing of the incoming call is detected (Yes at Step S305), the control unit 10 proceeds to Step S306. At Step S306, the control unit 10 performs a third notification using a notification unit, and then terminates the notification process. When it is determined that informing of the incoming call is not detected (No at Step S305), the control unit 10 proceeds to Step S307.

The control unit 10 determines at Step S307 whether the incoming call history data is received. The incoming call history data is the data transmitted through the incoming call history transmission process illustrated in FIG. 7. When it is determined that the incoming call history data is received (Yes at Step S307), the control unit 10 proceeds to Step S308. At Step S308, the control unit 10 performs a fourth notification using a notification unit. When it is determined that the incoming call history data is not received (No at Step S307), the control unit 10 terminates the notification process.

The processing steps illustrated in FIG. 8 are performed for the notification, and the control unit 10 performs a required process following these steps as necessary. The first notification, the second notification, the third notification, and the fourth notification in the processing steps illustrated in FIG. 8 may be each set such that the combination of the functional units that perform the notification and the mode of notification by sound, light, vibration, and the like differ from one type of notification to another.

By varying the mode of notification according the type of information relating to the incoming call as described above, the mobile phone 30 allows the user to readily identify the specific type of information that has been received.

Examples of cases in which informing by the short-range wireless communication is unavailable in the above description include, but are not limited to, a case in which a first terminal is unable to receive a signal from a second terminal due to, for example, an enlarged distance between the two terminals; and a case in which the short-range wireless communication function of the terminal is set to be unavailable. Examples of cases in which the communication over the public line network 90 is unavailable in the above description include, but are not limited to, a case in which signals transmitted from the base stations 91a and 91b are not caught (out of a communication range).

Changes in form and detail may be made in the embodiment disclosed in this application without departing from the spirit and scope of the disclosure. Additionally, the embodiment disclosed in this application and modifications thereof may be combined as appropriate. For example, the above embodiments may be modified as follows.

For example, each of the programs illustrated in FIGS. 3 and 5 may be divided into a plurality of modules or combined with another.

The above embodiments have been described for a case in which the mobile phone 20 and the mobile phone 30 are used by the same user. The owner of each of these electronic devices may not necessarily be the same user.

The above embodiments have been described for a case in which the first communication scheme is the short-range wireless communication scheme and the second communication scheme is a communication scheme for performing communication via the public line network 90. The combination of the communication schemes is, however, not limited thereto. The second communication scheme is only required to enable telephone conversation. The first communication scheme is only required to be used for transferring an incoming call through the second communication scheme to another electronic device.

The above embodiments have been described for a case in which an electronic device that transfers incoming calls differs in configuration from an electronic device to which the incoming calls are transferred. Nonetheless, one electronic device may still be configured so as to function as both the electronic device that transfers incoming calls and the electronic device to which the incoming calls are transferred.

The above embodiments have been described for the mobile phone as the electronic device that transfers incoming calls. The electronic device according to the appended claims is, however, not limited to a mobile phone. The electronic device according to the appended claims is required only to be capable of transferring incoming calls. Examples of the devices capable of transferring incoming calls include, but are not limited to, a stationary telephone set, a facsimile machine, and a personal computer including a modem.

Although the art of appended claims has been described with respect to specific embodiments for a complete and clear disclosure, the appended claims are not to be thus limited but are to be construed as embodying all modifications and alternative constructions that may occur to one skilled in the art which fairly fall within the basic teaching herein set forth.

1. An electronic device, comprising:
a first communication unit configured to perform communication with a first electronic device using a first communication scheme;
a second communication unit configured to perform communicate with the first electronic device using a second communication scheme; and
a control unit configured to,
in a state in which the first communication unit cannot be used for informing the first electronic device of an incoming call from a second electronic device,
inform the first electronic device of the incoming call using the second communication unit.

2. The electronic device according to claim 1, wherein the first communication scheme is short-range wireless communication.

3. The electronic device according to claim 1, wherein
the state in which the first communication unit cannot be used for informing the first electronic device includes
a state in which communication by the first communication unit is unavailable and
a state in which communication by the first communication unit is unstable.

4. The electronic device according to claim 1, further comprising:
a storage unit configured to store therein, when neither the first communication unit nor the second communication unit cannot be used for informing the first electronic device of the incoming call from the second electronic device, information on the incoming call, wherein,
when either one of the first communication unit or the second communication unit turns to be available for the informing,
the control unit transmits the information stored in the storage unit to the first electronic device using the one.

5. The electronic device according to claim 1, further comprising:
a notification unit configured to perform a notification relating to an incoming call or informing of an incoming call, wherein
the control unit varies a mode of the notification performed by the notification unit between when an incoming call is detected by the first communication unit, when an incoming call is detected by the second communication unit, and when informing of an incoming call is detected by the second communication unit.

6. A transfer control method by an electronic device including a first communication unit and a second communication unit, the transfer control method comprising:
detecting an incoming call from a second electronic device;
informing a first electronic device of the incoming call using the first communication unit; and
when the first communication unit cannot be used for informing the first electronic device of the incoming call, informing the first electronic device of the incoming call using the second communication unit.

7. An electronic device, comprising:
a first communication unit configured to perform communication with a first electronic device using a first communication path;
a second communication unit configured to perform communicate with the first electronic device using a second communication path; and
a control unit configured to,
in a state in which the first communication path cannot be used for informing the first electronic device of an incoming call from a second electronic device,
inform the first electronic device of the incoming call using the second communication path.
